(19) United States
(12) Patent Application Publication
(10) Pub. No.: US 2011/0020534 A1
(43) Pub. Date: Jan. 27, 2011

(54) BATTERY ELECTRODE MAKING METHOD

(76) Inventors: Kan-Sen CHOU, Hsinchu City (TW); Chen-Yu Kao, Hsinchu City (TW)

Correspondence Address: SINORICA, LLC, 2275 Research Blvd., Suite 500, ROCKVILLE, MD, 20850, US

(21) Appl. No.: 12/603,945

(22) Filed: Oct. 22, 2009

(30) Foreign Application Priority Data
Jul. 21, 2009 (TW) 098124508

(51) Int. Cl. B05D 5/12

(52) U.S. Cl. 427/58

(57) ABSTRACT

A manufacturing method of a battery electrode includes the following steps: providing a reducing reagent, a conductive adjuvant, and a solution comprising ferric ion, wherein the conductive adjuvant is selected from the group consisting of a metallic salt, a metal particle, a metal compound and a carbon conductive substance; applying the conductive adjuvant into the solution comprising ferric ion to form a first mixture solution, followed by mixing the first mixture solution with the reducing reagent to form a second mixture solution, wherein the conductive adjuvant and the ferric ion are reduced by the reducing reagent to form a composite micro-particle comprising iron micro-particle; isolating the composite micro-particle from the second mixture solution; providing an adhesive reagent and mixing with the composite micro-particle to form a coating reagent; and applying the coating reagent onto a metal mesh to produce the battery electrode.

### BACKGROUND OF THE INVENTION

1. Field of the Invention

The present invention discloses a manufacturing method of a battery electrode.

More particularly, the present invention discloses a manufacturing method of a battery electrode consisting primarily of iron.

2. Description of the Prior Art

Generally, a nickel-iron battery is structured with a negative electrode using ferric powder, a positive electrode using nickel hydroxide, electrolytic solution generally being potassium hydroxide solution, and a separating coating between the electrodes to separate the electrodes thereof. The capacity of the ferric electrode of a nickel-iron battery was limited in the past such that the overall energy density of a battery was only 50 Wh/kg and the power density thereof was also merely 100 W/kg, on top of high self-discharge effect. Therefore, nickel-iron batteries were gradually replaced by lead acid batteries, lithium batteries, etc. in the 1970's. However, compared with other batteries, nickel-iron batteries still hold advantages such as extremely long cycle period (>1000 cycle), over-charge and -discharge endurance, sufficient source materials, and eco-friendly, etc.

U.S. Pat. No. 4,356,101 of Jackovitz et al. filed in 1982 discussed reducing ferric oxide prepared from ferric sulfate as precursor with hydroxide at 700° C., thereby producing active iron powder with a capacity as high as 620 mAh/g; however, whether it was the actual cyclic capacity or the first-time discharge capacity was not elaborated. Research document of Huang published in 2007 also indicated that using nano-iron micro-particles prepared by chemical reduction as the material for ferric electrodes could provide 200 mA/g-Fe current with capacity up to 510 mAh/g-Fe, without applying any conductive adjuvant and activator. This implies that high surface area ratio of nano-iron micro-particle indeed effectively enhances utilization of the ferric atoms. Nevertheless, electrical capacity of a nano-iron electrode is different from that of a traditional battery electrode in that the former will decrease as the number of charge-discharge cycles increase (See FIG. 1). It is discovered from observation of micro-structure that, during its charge-discharge process, particle diameter of the nano-iron micro-particle increases so rapidly that the surface area thereof decreases accordingly, the reason for the increased particle diameter being that the ferric ions recrystallize into iron micro-particles during charging. Meanwhile, system tends to move towards a direction more thermodynamically stabilized, resulting in the reduction of the particle surface energy and particle size growth. It's observed from analyzed X-ray diffraction (XRD) results that, crystallinity of the nano-iron micro-particle becomes more and more prominent by the charge-discharge cycle, which reveals that recrystallization does take place in the nano-iron micro-particle, enabling particles originally in amorphous state to be transformed into well-crystallized state.

Various disadvantages mentioned above exist for the ferric electrode of nickel-iron batteries. Therefore, it is necessary to provide a battery electrode with better charge-discharge cycle characteristics and large current capacity to solve issues faced with present nickel-iron batteries.

### SUMMARY OF THE INVENTION

To overcome the disadvantages discussed above, the present invention discloses a manufacturing method of a battery electrode. The method includes providing a reducing reagent, a conductive adjuvant, and a solution comprising ferric ions; next applying the conductive adjuvant into the solution to form a first mixture solution, which is then mixed with the reducing reagent to form a second mixture solution; then isolating a composite micro-particle comprising at least one of conductive substances from the second mixture solution with a magnet; and finally mixing an adhesive reagent with the composite micro-particle to form a coating reagent, and applying the coating reagent onto a metal mesh.

Thus, the main purpose of the present invention is to provide a manufacturing method of a battery electrode to enable the electrode consisting primarily of ferric ions with better charge-discharge cycle.

The other objective of the present invention is to provide a manufacturing method of a battery electrode to produce a battery electrode with large current capacity.

### BRIEF DESCRIPTION OF THE DRAWING

FIG. 1 is a diagram depicting the relationship between capacitance and the number of charge-discharge cycles of a prior-art nano ferric electrode.

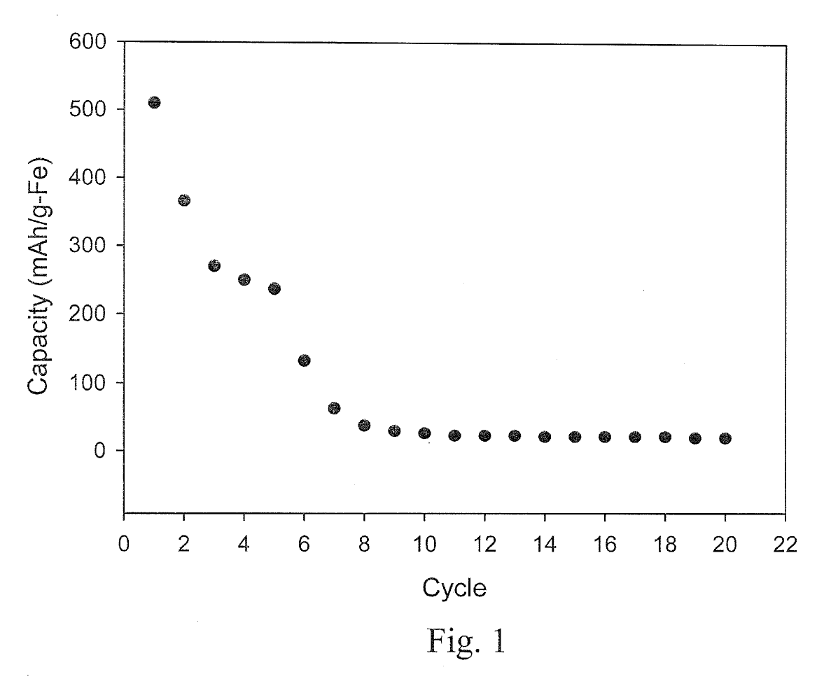

FIG. 2 is a flow chart showing the manufacturing method according to a first preferred embodiment of the present invention.

FIG. 3 is a curve showing the first discharge of the nano-scale ferric composite micro-particle electrode according to the present invention.

FIG. 4 is a comparison chart illustrating the number of charge-discharge cycles of the nano-scale ferric composite micro-particle electrode and the pure iron micro-particle electrode according to the present invention.

FIG. 5 is a curve showing the large-current discharge of the nano-scale ferric composite micro-particle electrode according to the present invention.

FIG. 6 is an electronmicroscopic (EM) photograph showing the nano-scale ferric composite micro-particle according to the present invention.

### DETAILED DESCRIPTION OF THE EMBODIMENTS

The present invention discloses a manufacturing method of battery electrode materials, wherein physical and chemical principles applied are known to those skilled in the art, and thus will not be described in detail hereinafter. Meanwhile, it is to be understood that drawings corresponding to the following descriptions are to illustrate demonstrations related to characteristics of the present invention, not and no need to be fully drawn based on actual conditions.

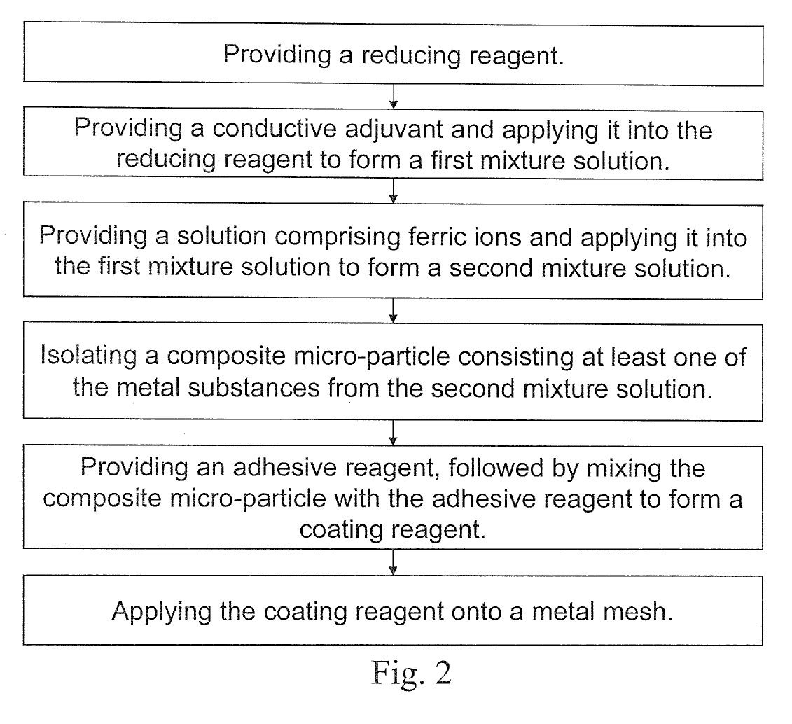

Refer to FIG. 2, which depicts a preferred embodiment of the manufacturing method of a battery electrode according to the present invention, including: providing a reducing reagent; providing a conductive adjuvant comprising one of metallic salt, metal micro-particle, metal compound, and carbon conductive substance; providing a solution comprising ferric ions, followed by applying the conductive adjuvant into the solution to form a first mixture solution; mixing the first mixture solution with the reducing reagent to form a second mixture solution, wherein the conductive adjuvant and the ferric ions are reduced by the reducing reagent to form a composite micro-particle comprising an iron micro-particle; isolating the composite micro-particle from the second mixture solution; providing an adhesive reagent, which is then mixed with the composite micro-particle to form a coating reagent; and applying the coating reagent onto a metal mesh to produce the electrode.

In the foregoing embodiment, the reducing reagent consists of a strong reducing reagent such as, but not limited to, NaBH₄ or KBH₄, and pure water. The conductive adjuvant may comprise a metallic salt such as Co, Ni, Cu, Sn, Sb, Bi, In, Au, Pb and Cd solutions, or may be directly applied of an extremely fine metal micro-particle or metal compound in the form of powder, filament, slice, etc. Taking the metal micro-particle for example, it is a micro-particle structure made up of pure metal atoms, and may further take the form of powder, filament, or slice. In the example of the metal compound, it refers to metal oxide or nitride, etc.

Further, the carbon substance may be carbon black, carbon nanotube, or graphite. In addition, the solution comprising the ferric ions discussed in the embodiment is soluble ferric compound solution, e.g. FeSO₄, Fe(NO₃)₃, FeCl₃, etc. The adhesive reagent is made up of Teflon.

Moreover, in the foregoing embodiment, an inhibitor may further be applied, wherein the inhibitor comprises molybdate, phosphate, organophosphorus compound, silicate, chromate, long carbon chain organic compound with polarized base group, surfactant, etc., to retard the self-discharge effect of the ferric electrode by various mechanisms.

Further, the manufacturing method disclosed in the foregoing embodiment utilizes chemical reducing deposition, producing micro-particles with very small diameters, wherein the iron micro-particle is of nano-scale to enable compact combination of the conductive adjuvant and the active iron micro-particle. In addition, a mass of heterogeneous micro-particles are distributed evenly in the electrode, serving as the place where a core is precedingly formed after dissolving in the crystallized ferric ions during charging, to effectively avoid the diameter from increasing, enabling the electrode to have excellent charge-discharge characteristic and large current capacity.

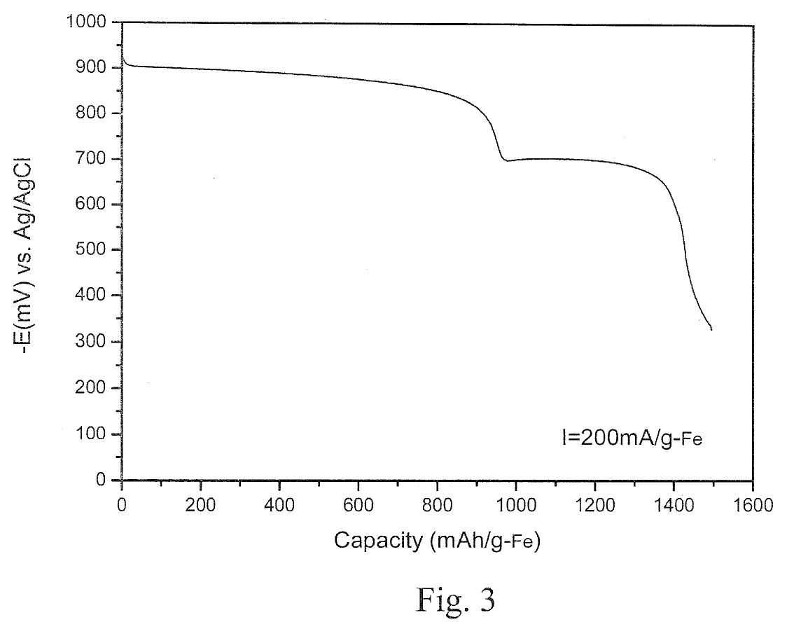

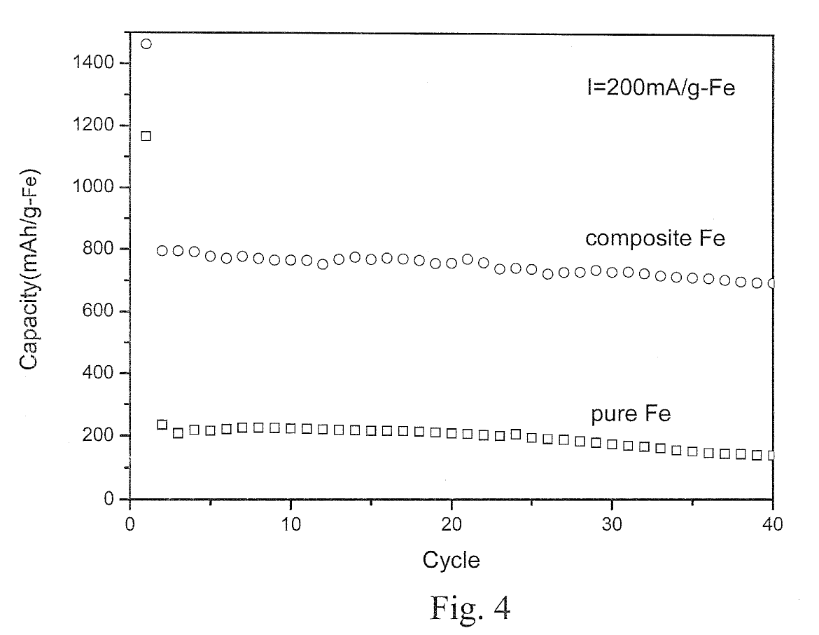

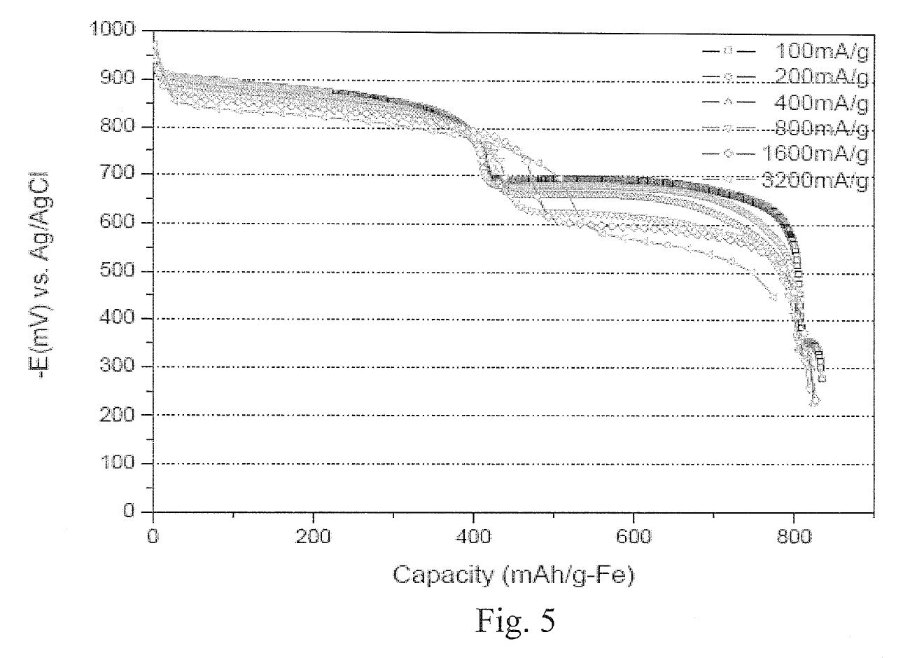

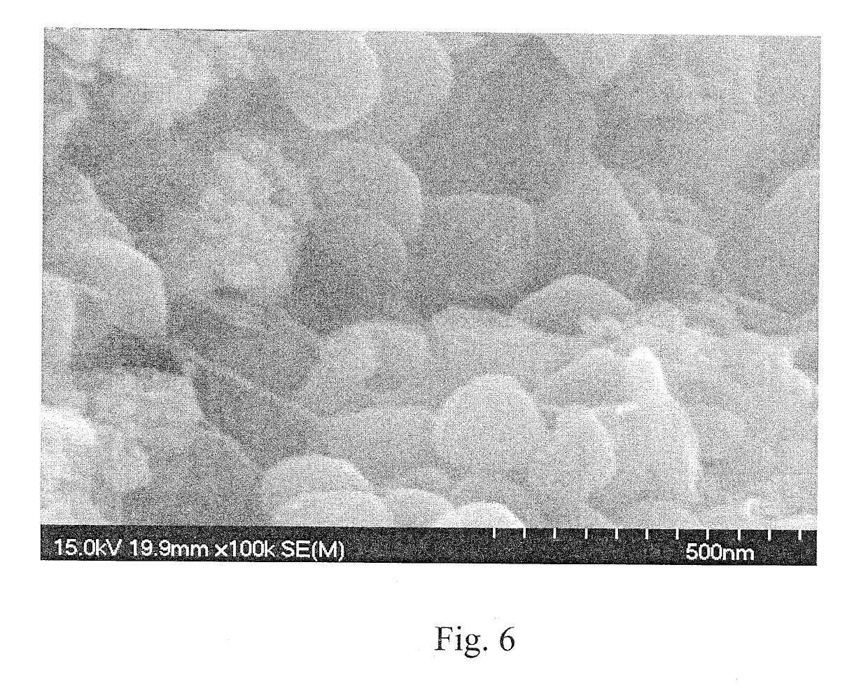

With reference to FIG. 3, the composite iron micro-particle produced by the manufacturing method according to the present invention can release approximately the theoretical capacity (i.e. first stage theoretical capacity 960 mAh/g) during the first discharge. After the second discharge-charge cycle, the original composite iron micro-particle is dissolved and recrystallized, with the capacity of the first stage decreasing down to 400 to 600 Ah/g-Fe. Total capacity of the two stages is about 800 mAh/g-Fe, while cyclic capacity thereafter remains stable, higher than that of existing hydrogen storage alloy (i.e. 300±20 mAh/g). Next, with reference to FIG. 4, 90% of the capacity can still remain after 40 charge-discharge cycles. Continuing on to FIG. 5, the discharge voltage of the electrode material at a 3200 mA/g current is only 0.06V lower than that of the electrode discharging at a 100 mA/g current, showing that the discharging ability at large current is far better than traditional ferric electrode materials. Referring to FIG. 6, the diameter of composite micro-particle through electron microscopic observation is between 100 and 200 nanometers.

The present invention will be described with reference to the following example, which is not to limit privileges of the claims of the present invention.

### Example

At first, dissolve 0.1 mole of sodium borohydride (NaBH₄) in 100 ml pure water to serve as the reducing reagent. Then, slowly mix the 100 ml mixture solution containing 0.025 mole of FeSO₄.7H₂O and 0.0025 to 0.05 mole of metallic salt or micro conductive substance with the reducing reagent, enabling the metallic salt or the micro conductive substance and ferric sulfate to generate reduction reaction together, forming the composite micro-particle consisting of the conductive substance and the ferric ions. The metallic salt may consist of Co, Ni, Cu, Sn, Sb, Bi, In, Ag, Au, Pb or Cd, and the micro conductive substance may be metal powder, metal filament, metal slice, carbon black, carbon nanotube, or graphite. After the reduction is completed, rinse several times by pure water, followed by isolating with a magnet to obtain the composite micro-particle consisting of the ferric ions and the conductive substance. Add into the composite micro-particle perfluoroethylene (Teflon, PTFE) with a weight percentage of 10% to serve as the adhesive reagent and mix up to prepare the coating reagent, which is then applied onto the current collecting mesh to produce the electrode.

What is disclosed above is only the preferred embodiments of the present invention, not to limit privileges of the claims thereof. Meanwhile, descriptions mentioned above should be understood and performed by those skilled in the art; therefore, any other changes or amendments applied under the spirits revealed in the present invention should be included in the claims appended.

What is claimed is:

1. A battery electrode making method, comprising:
providing a reducing reagent;
providing a conductive adjuvant selected from the group consisting of a metallic salt, a metal micro-particle, a metal compound, and a carbon conductive substance;
providing a solution comprising ferric ions and applying the conductive adjuvant into the solution comprising ferric ions to form a first mixture solution;
mixing the first mixture solution with the reducing reagent to form a second mixture solution, wherein the conductive adjuvant and the ferric ions are reduced by the reducing reagent to form a composite micro-particle comprising an iron micro-particle;
isolating the composite micro-particle from the second mixture solution;
providing an adhesive reagent and mixing the composite micro-particle and the adhesive reagent to form a coating reagent; and
applying the coating reagent onto a metal mesh to produce the battery electrode.

2. The method of claim 1, wherein the reducing reagent comprises NaBH₄ and pure water.

3. The method of claim 1, wherein the reducing reagent comprises KBH₄ and pure water.

4. The method of claim 1, wherein the metallic salt is selected from the group consisting of Co, Ni, Cu, Sn, Sb, Bi, In, Au, Pb and Cd.

5. The method of claim 1, wherein the metal micro-particle is in the form of powder, filament or slice.

6. The method of claim 1, wherein the metal micro-particle is selected from the group consisting of Co, Ni, Cu, Sn, Sb, Bi, In, Au, Pb, Cd and Ti.

7. The method of claim 1, wherein the metal compound is selected from the group consisting of Co, Ni, Cu, Sn, Sb, Bi, In, Au, Pb, Cd and Ti.

8. The method of claim 1, wherein the carbon conductive substance is carbon black, carbon nanotube or graphite.

9. The method of claim 1, wherein the metal compound is in the form of powder, filament or slice.

10. The method of claim 1, wherein the carbon conductive substance is in the form of powder, filament, or slice.

11. The method of claim 1, wherein the solution comprising ferric ions is selected from the group consisting of FeSO₄ solution, Fe(NO₃)₃ solution and FeCl₃ solution.

12. The method of claim 1, wherein the diameter of the iron micro-particle is of nanometer scale.

13. The method of claim 1, wherein the diameter of the composite micro-particle is between 100 nm and 200 nm.

14. The method of claim 1, wherein the adhesive reagent is perfluoroethylene.

15. The method of claim 1, further comprising applying an inhibitor.

16. The method of claim 14, wherein the inhibitor is selected from the group consisting of molybdate, phosphate, organophosphorus compound, silicate, chromate, long carbon chain organic compound with polarized base group, and surfactant.

17. The method of claim 1, wherein the isolating of the metal composite micro-particle from the second mixture solution is performed by using a magnet.
